(19) United States
(12) Patent Application Publication
(10) Pub. No.: US 2011/0157395 A1
(43) Pub. Date: Jun. 30, 2011

(54) IMAGE SENSOR WITH FRACTIONAL RESOLUTION IMAGE PROCESSING

(76) Inventor: John T. Compton, LeRoy, NY (US)

(21) Appl. No.: 12/947,879

(22) Filed: Nov. 17, 2010

Related U.S. Application Data
(60) Provisional application No. 61/335,124, filed on Dec. 31, 2009.

(51) Int. Cl. H04N 5/228

(52) U.S. Cl. 348/222.1; 348/E05.031

(57) ABSTRACT

A system-on-chip (SOC) includes an image sensor, an image signal processor connected to an output of the image sensor, a bypass connected to the output of the image sensor, and a multiplexer connected to an output of the image signal processor and an output of the bypass. The image sensor, image signal processor, bypass, and multiplexer are all integrated on one silicon wafer. An image capture device includes the SOC and applications processor connected to an output of the multiplexer. The image capture device can further include a system memory and a display connected to the applications processor.

### CROSS-REFERENCE TO RELATED APPLICATION

This application claims the benefit of U.S. Provisional Patent Application 61/335,124 filed on Dec. 30, 2009.

### TECHNICAL FIELD

The present invention relates to image sensors for use in digital cameras and other types of image capture devices.

### BACKGROUND

Conventional image sensors typically capture images using a two-dimensional array of photosensitive areas. A color filter array (CFA) can be disposed over the array of photosensitive areas so that each photosensitive area receives light propagating at predetermined wavelengths. For example, a Bayer CFA includes color filter elements that allow each pixel in the array to receive light corresponding to the color red, green, or blue. Another type of CFA includes both panchromatic filter elements and color filter elements. This type of CFA is known as a sparse CFA. A pixel with a panchromatic filter element has a photo-response having a wider spectral sensitivity than the photo-responses of the pixels with color filter elements.

An image sensor that incorporates image processing is known as a “system-on-chip” (SOC) image sensor. An SOC image sensor includes memories and processing resources sufficient to handle images captured with the full-resolution of the image sensor. Generally, compromises in image processing robustness or quality are required in order to reduce the size of the image processing so that it does not consume too much silicon area.

Processing images captured by an image sensor with a sparse CFA generally requires many line buffers of memory and significant computational resources. This makes it problematic to include such processing hardware on an SOC image sensor because the line buffers and memory consume too much silicon area. Nevertheless, including image processing on the sensor silicon is desirable, as it eliminates the need for additional chips in a system.

### SUMMARY

A system-on-chip (SOC) includes an image sensor, an image signal processor connected to an output of the image sensor, a bypass connected to the output of the image sensor, and a multiplexer connected to an output of the image signal processor and an output of the bypass. The image sensor, image signal processor, bypass, and multiplexer are all integrated on one silicon wafer. An image capture device includes the SOC and applications processor connected to an output of the multiplexer. The image capture device can also include a system memory connected to the applications processor. The image capture device can also include a display.

A method for processing images in an image capture device that includes an applications processor, a system memory, a display, and the SOC includes processing fractional resolution image data using the image signal processor if fractional resolution image data is received from the image sensor. The processed fractional resolution image data is then transmitted to the applications processor through the multiplexer. If full resolution image data is received from the image sensor, the full resolution image data is transmitted to the applications processor through the bypass and multiplexer. The full resolution image data can be processed by the applications processor. The processed full resolution image data can be stored in the system memory or displayed on a display. The full resolution image data can be stored in the system memory. The full resolution image data can be displayed on the display.

### BRIEF DESCRIPTION OF THE DRAWINGS

Embodiments of the invention are better understood with reference to the following drawings. The elements of the drawings are not necessarily to scale relative to each other.

FIG. 1 is a block diagram of an image capture device in an embodiment in accordance with the invention;

FIG. 2 is a block diagram of an image capture device with image processing integrated into the image sensor in an embodiment in accordance with the invention;

FIGS. 3A-3C are block diagrams of alternate structures for an image capture device with integrated image processing in an embodiment in accordance with the invention;

FIG. 4A is a more detailed block diagram a system-on-chip in embodiments in accordance with the invention;

FIGS. 4B-4C illustrate different image data paths for SOC 414 in an embodiment in accordance with the invention;

FIGS. 5A-5C illustrate exemplary embodiments of a color filter array pattern that include both color filter elements and panchromatic filter elements suitable for use in embodiments in accordance with the invention;

FIGS. 5D-5F depict a method of producing fractional resolution image data for the color filter array pattern shown in FIG. 5A;

FIG. 6A illustrates a Bayer color filter array pattern suitable for use with the present invention;

FIGS. 6B-6E depict a method of producing fractional resolution image data for the Bayer color filter array pattern;

FIG. 6F illustrates the resulting fractional resolution image data produced by the method shown in FIGS. 6B-6E;

FIG. 7 depicts an image processing chain for fractional resolution image processing in an embodiment in accordance with the invention; and

FIG. 8 illustrates an image processing chain for full resolution image processing in an embodiment in accordance with the invention.

### DETAILED DESCRIPTION

Throughout the specification and claims, the following terms take the meanings explicitly associated herein, unless the context clearly dictates otherwise. The meaning of “a,” “an,” and “the” includes plural reference, the meaning of “in” includes “in” and “on.” The term “connected” means either a direct electrical connection between the items connected, or an indirect connection through one or more passive or active intermediary devices. The term “circuit” means either a single component or a multiplicity of components, either active or passive, that are connected together to provide a desired function. The term “signal” means at least one current, voltage, or data signal.

Additionally, directional terms such as “on”, “over”, “top”, “bottom”, are used with reference to the orientation of the Figure(s) being described. Because components of embodiments of the present invention can be positioned in a number of different orientations, the directional terminology is used for purposes of illustration only and is in no way limiting. When used in conjunction with layers of an image sensor wafer or corresponding image sensor, the directional terminology is intended to be construed broadly, and therefore should not be interpreted to preclude the presence of one or more intervening layers or other intervening image sensor features or elements. Thus, a given layer that is described herein as being formed on or formed over another layer may be separated from the latter layer by one or more additional layers.

And finally, the term “wafer” is to be understood as a semiconductor-based material including, but not limited to, silicon, silicon-on-insulator (SOI) technology, silicon-on-sapphire (SOS) technology, doped and undoped semiconductors, epitaxial layers or well regions formed on a semiconductor substrate, and other semiconductor structures.

Referring to the drawings, like numbers indicate like parts throughout the views.

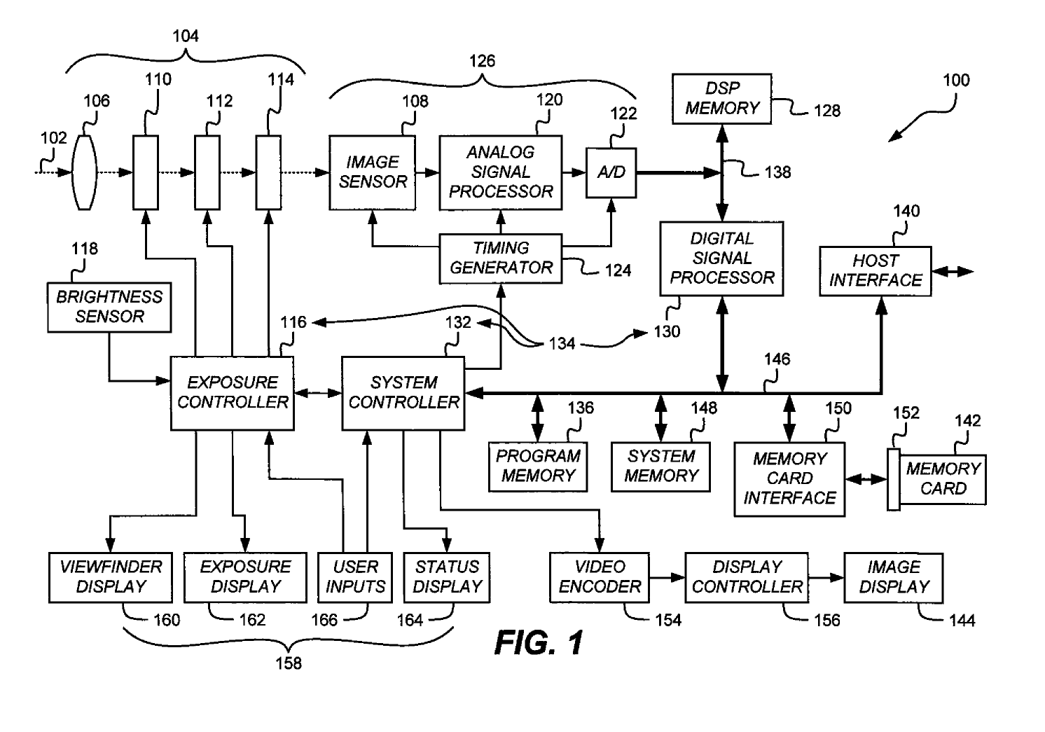

FIG. 1 is a block diagram of an image capture device in an embodiment in accordance with the present invention. Image capture device 100 is implemented as a digital camera in FIG. 1, but the present invention is applicable to other types of image capture devices. Examples of different types of image capture device include, but are not limited to, a scanner, a digital video camera, and mobile or portable devices that include one or more cameras.

Light 102 from the subject scene is input to an imaging stage 104, where the light is focused by lens 106 to form an image on image sensor 108. Image sensor 108 converts the incident light to an electrical signal for each picture element (pixel). Image sensor 108 is implemented as an active pixel image sensor, such as a Complementary Metal Oxide Semiconductor (CMOS) image sensor, in an embodiment in accordance with the invention. Image sensor 108 can be configured differently in other embodiments in accordance with the invention. For example, image sensor 108 can be implemented as charge coupled device (CCD) image sensor.

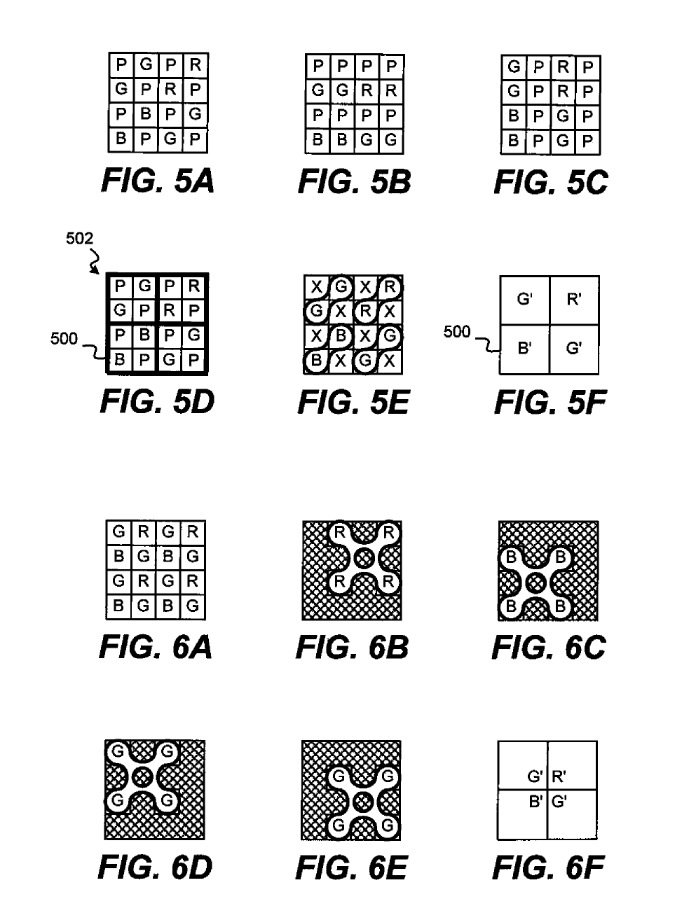

Pixels on image sensor 108 typically have a color filter array (CFA) (not shown in FIG. 1) applied over the pixels so that each pixel senses a portion of the imaging spectrum. Examples of red (R), green (G), and blue (B) and red, green, blue and panchromatic (P) CFA patterns of pixels are shown in FIGS. 5A-5F and 6A-6F, although different patterns and different color combinations such as cyan, magenta and yellow, can be used in other embodiments in accordance with the invention.

The light passes through lens 106 and filter 110 before being sensed by image sensor 108. Optionally, the light passes through a controllable iris 112 and mechanical shutter 114. Filter 112 comprises an optional neutral density (ND) filter for imaging brightly lit scenes. The exposure controller block 116 responds to the amount of light available in the scene as metered by the brightness sensor block 118 and regulates the operation of filter 110, iris 112, shutter 114, and the integration period (or exposure time) of image sensor 108 to control the brightness of the image as sensed by image sensor 108. Image sensor 108, iris 112, shutter 114, exposure controller 116, and brightness sensor 118 form an auto exposure system in one embodiment in accordance with the invention.

This description of a particular camera configuration will be familiar to one skilled in the art, and it will be obvious that many variations and additional features are present. For example, an autofocus system is added, or the lenses are detachable and interchangeable. It will be understood that the present invention is applied to any type of digital camera, where similar functionality is provided by alternative components. For example, the digital camera can be a relatively simple point and shoot digital camera, where shutter 114 is a relatively simple movable blade shutter, or the like, instead of a more complicated focal plane arrangement as is found in a digital single lens reflex camera. The present invention can also be practiced on imaging components included in simple camera devices such as mobile phones and automotive vehicles which can be operated without controllable irises 112 and without mechanical shutters 114. Lens 106 can be a fixed focal length lens or a zoom lens.

The analog signal from image sensor 108 is processed by analog signal processor 120 and applied to analog to digital (A/D) converter 122. Timing generator 124 produces various clocking signals to select rows and pixels, to transfer charge packets out of image sensor 108, and synchronize the operation of analog signal processor 120 and A/D converter 122. The image sensor stage 126 includes image sensor 108, analog signal processor (ASP) 120, A/D converter 122, and timing generator 124. The components of image sensor stage 126 are separately fabricated integrated circuits, or they are fabricated as a single integrated circuit as is commonly done with CMOS image sensors. The resulting stream of digital pixel values from A/D converter 122 is stored in memory 128 associated with digital signal processor (DSP) 130.

Digital signal processor 130 is one of three processors or controllers in this embodiment, in addition to system controller 132 and exposure controller 116. Although this partitioning of camera functional control among multiple controllers and processors is typical, these controllers or processors are combined in various ways without affecting the functional operation of the camera and the application of the present invention. These controllers or processors can comprise one or more digital signal processor devices, microcontrollers, programmable logic devices, or other digital logic circuits. Although a combination of such controllers or processors has been described, it should be apparent that one controller or processor can be designated to perform all of the needed functions. All of these variations can perform the same function and fall within the scope of this invention, and the term “processing stage” will be used as needed to encompass all of this functionality within one phrase, for example, as in processing stage 134 in FIG. 1.

In the illustrated embodiment, DSP 130 manipulates the digital image data in memory 128 according to a software program permanently stored in program memory 136 and copied to memory 128 for execution during image capture. DSP 130 executes the software necessary for practicing the image processing of the invention. Memory 128 includes any type of random access memory, such as SDRAM. Bus 138 comprising a pathway for address and data signals connects DSP 130 to memory 128, A/D converter 122, and other related devices.

System controller 132 controls the overall operation of the camera based on a software program stored in program memory 136, which can include Flash EEPROM or other nonvolatile memory. This memory can also be used to store image sensor calibration data, user setting selections and other data which must be preserved when the camera is turned off. System controller 132 controls the sequence of image capture by directing exposure controller 116 to operate lens 106, filter 110, iris 112, and shutter 114 as previously described, directing the timing generator 124 to operate image sensor 108 and associated elements, and directing DSP 130 to process the captured image data. After an image is captured and processed, the final image file stored in memory 128 is transferred to a computer via host interface 140, stored on a removable memory card 142 or other storage device, and displayed for the user on image display 144.

Bus 146 includes a pathway for address, data and control signals, and connects system controller 132 to DSP 130, program memory 136, system memory 148, host interface 140, memory card interface 150, and other related devices. Host interface 140 provides a high speed connection to a personal computer (PC) or other host computer for transfer of image data for display, storage, manipulation or printing. This interface is an IEEE 1394 or USB2.0 serial interface or any other suitable digital interface. Memory card 142 is typically a Compact Flash (CF) card inserted into socket 152 and connected to the system controller 132 via memory card interface 150. Other types of storage that are utilized include without limitation PC-Cards, MultiMedia Cards (MMC), or Secure Digital (SD) cards.

Processed images are copied to a display buffer in system memory 148 and continuously read out via video encoder 154 to produce a video signal. This signal is output directly from the camera for display on an external monitor, or processed by display controller 156 and presented on image display 144. This display is typically an active matrix color liquid crystal display (LCD), although other types of displays are used as well.

The user interface 158, including all or any combination of viewfinder display 160, exposure display 162, status display 164, image display 144, and user inputs 166, is controlled by a combination of software programs executed on exposure controller 116 and system controller 132. User inputs 166 typically include some combination of buttons, rocker switches, joysticks, rotary dials or touch screens. Exposure controller 116 operates light metering, exposure mode, autofocus and other exposure functions. System controller 132 manages the graphical user interface (GUI) presented on one or more of the displays, e.g., on image display 144. The GUI typically includes menus for making various option selections and review modes for examining captured images.

Exposure controller 116 accepts user inputs selecting exposure mode, lens aperture, exposure time (shutter speed), and exposure index or ISO speed rating and directs the lens and shutter accordingly for subsequent captures. Optional brightness sensor 118 is employed to measure the brightness of the scene and provide an exposure meter function for the user to refer to when manually setting the ISO speed rating, aperture and shutter speed. In this case, as the user changes one or more settings, the light meter indicator presented on viewfinder display 160 tells the user to what degree the image will be over or underexposed. In an alternate case, brightness information is obtained from images captured in a preview stream for display on the image display 144. In an automatic exposure mode or with an auto exposure system, the user changes one setting and the exposure controller 116 automatically alters another setting to maintain correct exposure, e.g., for a given ISO speed rating when the user reduces the lens aperture, the exposure controller 116 automatically increases the exposure time to maintain the same overall exposure. In a fully automatic mode or with an auto exposure system, the user selects the fully automatic mode and the image capture device determines the settings for image capture based on measurements of the scene.

The image sensor 108 shown in FIG. 1 typically includes a two-dimensional array of pixels each having a photosensitive area fabricated on a silicon substrate that provides a way of converting incoming light at each pixel into an electrical signal that is measured. The pixels can be arranged on the image sensor in lines comprised of rows and columns. As the sensor is exposed to light, free charge carriers are generated and captured within the electronic structure at each pixel. Capturing these free charge carriers or photo-generated charge packets for some period of time and then measuring the number of carriers captured, or measuring the rate at which free charge carriers are generated measures the light level at each pixel. In the former case, accumulated charge packets are shifted out of the array of pixels to a charge to voltage measurement circuit as in a CCD image sensor.

The foregoing description of a digital camera will be familiar to one skilled in the art. It will be obvious that there are many variations of this embodiment that are possible and are selected to reduce the cost, add features or improve the performance of the camera.

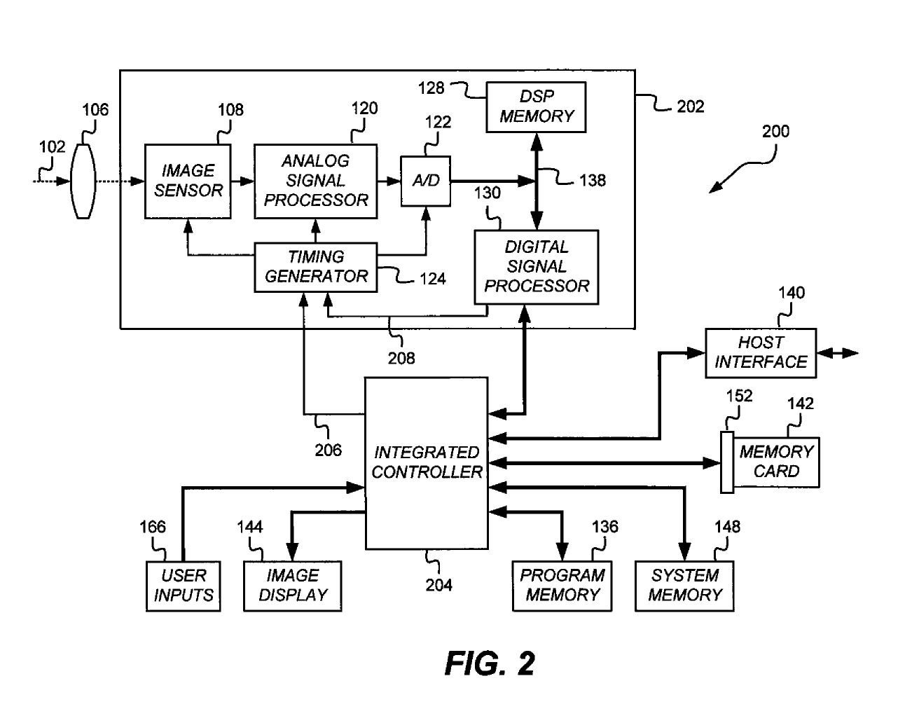

Referring now to FIG. 2, there is shown a block diagram of an image capture device with image processing integrated into the image sensor in an embodiment in accordance with the invention. Image capture device 200 includes integrated image sensor 202 and integrated controller 204. Integrated image sensor 202 includes image sensor 108, ASP 120, A/D converter 122, timing generator 124, DSP memory 128, and DSP 130 (shown in FIG. 1). Integrated image sensor 202 is known as a system-on-chip or SOC image sensor.

Integrated controller 204 incorporates the exposure controller 116, system controller 132, video encoder 154, and display controller 156 (see FIG. 1) in an embodiment in accordance with the invention. Some of the elements shown in FIG. 1 are included in the illustrated embodiment of FIG. 2. Additionally, some of the elements from FIG. 1 that are not shown in FIG. 2 can be included in other embodiments in accordance with the invention. By way of example only, an image capture device can include the viewfinder display, the exposure display, status display, and brightness sensor.

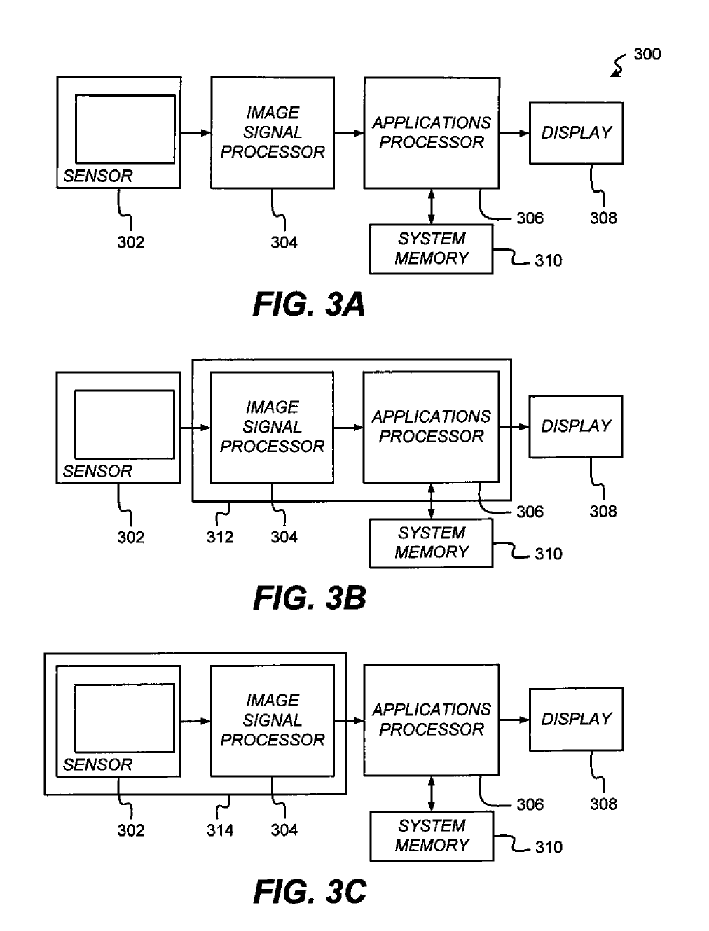

FIGS. 3A-3C are block diagrams of alternate structures for an image capture device with integrated image processing in an embodiment in accordance with the invention. In FIG. 3A, image sensor 302, image signal processor (ISP) 304, applications processor 306, and system memory 310 are all fabricated on separate individual silicon wafers. Image capture device 300 also includes display 308.

Alternatively, ISP 304 and applications processor 306 can be integrated into device 312 with image sensor 302 and system memory 310 on separate individual silicon wafers (FIG. 3B).

And another alternate embodiment integrates ISP 304 and image sensor 302 into device 314 with applications processor 306 and system memory 310 on separate individual silicon wafers (FIG. 3C). Device 314 is also known as a system-on-chip or SOC 314. Due to space limitations, technology limitations, or limitations in device fabrication techniques, the functionality of the image signal processing function may be limited when ISP 304 is integrated with image sensor 302. By way of example only, the number of lines of pixels employed for image processing may be limited, and the noise reduction techniques may be less computationally intensive. Moreover, providing a sufficient amount of memory to store an entire frame of image data is typically not an option when ISP 304 is integrated with image sensor 302.

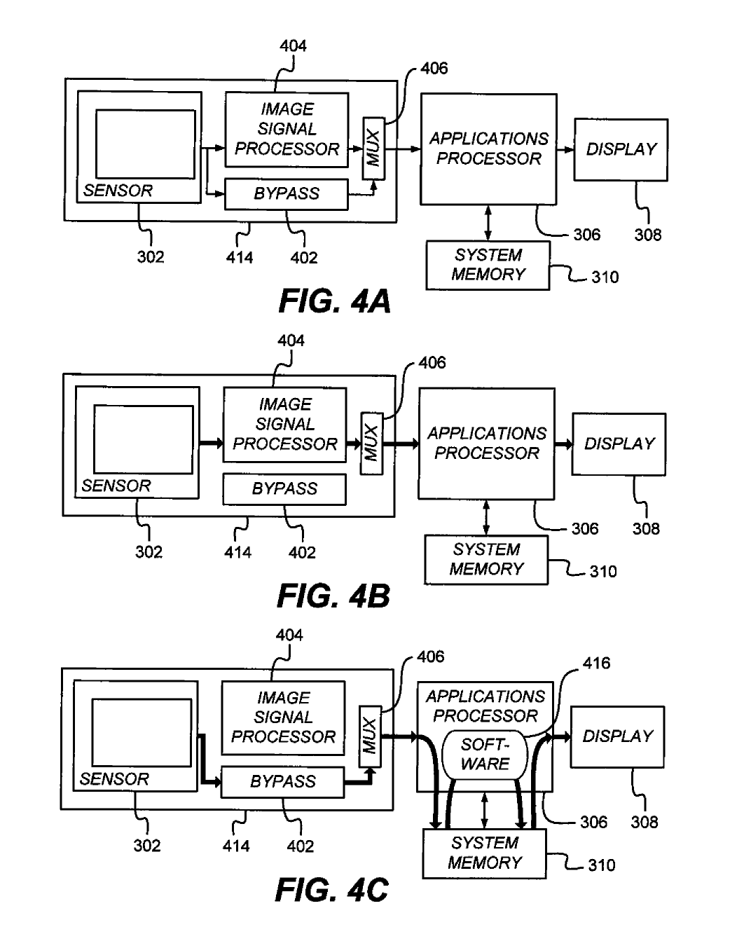

Referring now to FIG. 4A, there is shown a more detailed block diagram a system-on-chip in embodiments in accordance with the invention. FIG. 4A depicts SOC 414 including a fractional resolution ISP 404 integrated with image sensor 302. SOC 414 also includes a bypass 402 for transmitting full resolution image data directly to the applications processor 306. Multiplexer (MUX) 406 is used to direct image data from either ISPF 404 or bypass 402 to applications processor 306. The applications processor 306 can then store the full resolution image data in system memory 310 or display the data on display 308.

FIGS. 4B-4C illustrate different image data paths for SOC 414 in an embodiment in accordance with the invention. In FIG. 4B, fractional resolution image data is output from image sensor 302 and processed by ISP 404 when SOC is providing fractional resolution image processing. In FIG. 4C, full resolution image data is output from image sensor 302 and transmitted to applications processor 306 or system memory 310 via bypass 402 and MUX 406. Applications processor 302 can read image data from memory and process the image data by executing one or more software programs 416. Applications processor 306 can store the processed image data in memory 310. Image data or processed image data stored in system memory 310 can also be displayed on display 308.

In order to produce a color image, the array of pixels in an image sensor typically has a pattern of color filters placed over them. To improve the overall sensitivity of an image sensor, pixels that include color filters can be intermixed with pixels that do not include color filters (panchromatic pixels). As used herein, a panchromatic photoresponse refers to a photoresponse having a wider spectral sensitivity than those spectral sensitivities represented in the selected set of color photoresponses. A panchromatic photosensitivity can have high sensitivity across the entire visible spectrum. The term panchromatic pixel will refer to a pixel having a panchromatic photoresponse. Although the panchromatic pixels generally have a wider spectral sensitivity than the set of color photoresponses, each panchromatic pixel can have an associated filter. Such filter is either a neutral density filter or a color filter.

When a pattern of color and panchromatic pixels is on the face of an image sensor, each pattern has a repeating unit that is a contiguous subarray of pixels that acts as a basic building block. FIGS. 5A-5C illustrate examples of a CFA that includes both color filter elements and panchromatic filter elements suitable for use in embodiments in accordance with the invention. The color filter elements include green (G), red (R), and blue (B) color filter elements. The panchromatic filter elements are identified by the letter P. By juxtaposing multiple copies of the repeating unit, the entire sensor pattern is produced. The juxtaposition of the multiple copies of repeating units are done in diagonal directions as well as in the horizontal and vertical directions. Examples of CFA patterns are disclosed in United States Patent Application Publication 2007/0024931.

FIGS. 5D-5F depict a method of producing fractional resolution image data for the color filter array pattern shown in FIG. 5A. FIG. 5D illustrates the cell nature of FIG. 5A. An important feature of the FIG. 5A pattern is alternating panchromatic and color pixels with the color rows. In FIG. 5D, the groups of pixels (four pixels in a group) with the same photoresponse along with some of their neighboring panchromatic pixels are considered to form four cells 500 that make up the minimal repeating unit 502, a cell 500 being a contiguous subarray of pixels having fewer pixels than a minimal repeating unit 502.

FIG. 5E illustrates a method for combining pixels of the same color to reduce the resolution of the image data. The green, red, and blue pixels within each cell 500 are combined while the panchromatic pixels are discarded in an embodiment in accordance with the invention. Other embodiments in accordance with the invention do not have to discard the panchromatic pixels. The panchromatic pixels may be combined with the color pixels in each cell to improve photographic speed at the expense of color saturation.

The result of this combining is shown in FIG. 5F, where the four cells 500 each have one combined color. Images having combined pixel signals or colors like the one depicted in FIG. 5F have reduced or fractional resolutions.

The pixel signals are combined in the focal plane in an embodiment in accordance with the invention using techniques that are known in the art. By way of examples only, the pixel signals can be combined in the column circuits or in the pixel array during a readout process. The pixel signals do not have to be read out of the image sensor and combined thereafter. Techniques for producing lower resolution images are disclosed in United States Patent Application Publication 2008/0131028.

FIG. 6A illustrates a pattern of red, green, and blue color filters that is commonly used and known as a Bayer color filter array (CFA) after its inventor Bryce Bayer. The Bayer CFA is disclosed in U.S. Pat. No. 3,971,065. This pattern is effectively used in image sensors having a two-dimensional array of color pixels. As a result, each pixel has a particular color photoresponse that, in this case, is a predominant sensitivity to red, green or blue light. Another useful variety of color photoresponses is a predominant sensitivity to magenta, yellow, or cyan light. In each case, the particular color photoresponse has high sensitivity to certain portions of the visible spectrum, while simultaneously having low sensitivity to other portions of the visible spectrum.

FIGS. 6B-6E illustrate a method for combining red pixels, blue pixels, and two groups of green pixels to provide the fractional resolution result shown in FIG. 6F.

An image captured using an image sensor having a two-dimensional array with the CFA of FIG. 6A has only one color value at each pixel. In order to produce a full color image, there are a number of techniques for inferring or interpolating the missing colors at each pixel. These CFA interpolation techniques are well known in the art, and reference is made to the following patents: U.S. Pat. No. 5,506,619, U.S. Pat. No. 5,629,734, and U.S. Pat. No. 5,652,621.

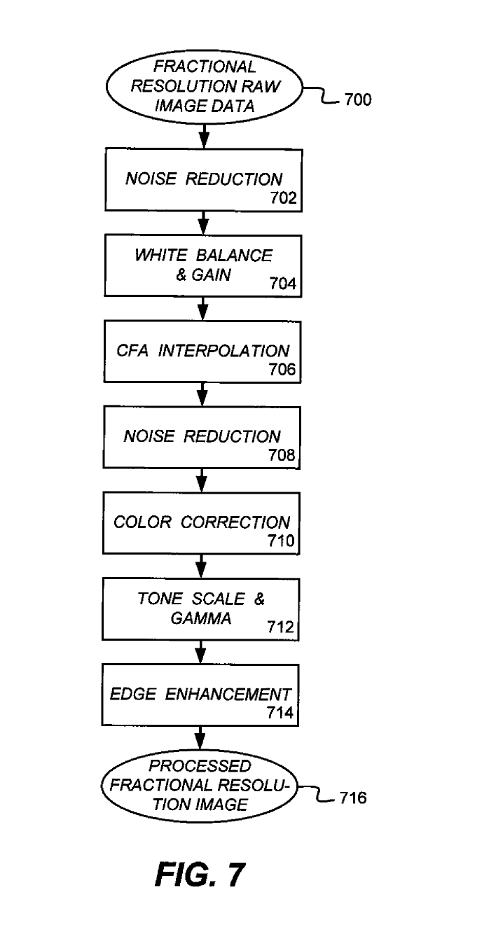

FIG. 7 depicts an image processing chain for fractional resolution image processing in an embodiment in accordance with the invention. The illustrated image processing chain is modeled after Adams/Hamilton (J. E. Adams, Jr. and J. F. Hamilton, Jr., “Digital Camera Processing Chain Design,” Single Sensor Imaging: Methods and Applications for Digital Cameras, (ed. R. Lukac, pp. 67-93, CRC Press, 2009). Given fractional resolution raw image data 700, noise reduction 702 is first applied to reduce or eliminate structured and stochastic noise. The white balance and overall gain 704 is applied to the image data in order to properly color balance the image and to adjust the image data for exposure. Since the raw image data represents a partial color image, i.e., an image in which each pixel has only a subset of the required colors (for example, the raw image data may be Bayer image data, in which case each pixel has only red, green, or blue data, and the remaining two colors for each pixel are missing), color filter array (CFA) interpolation 706 must be performed to determine the missing colors. After interpolation, an additional noise cleaning step 708 may be performed to reduce stochastic color noise. A non-linear transfer function may be applied to adjust the tone scale and gamma 712, and edge enhancement 718 may be applied to improve the apparent sharpness of the image. This sequence of steps provides a fully processed fractional resolution image 716. Note that the steps outlined here are representative of typical image processing chains for Bayer image data, but many variations, enhancements, and alternative processing orders for image processing chains exist.

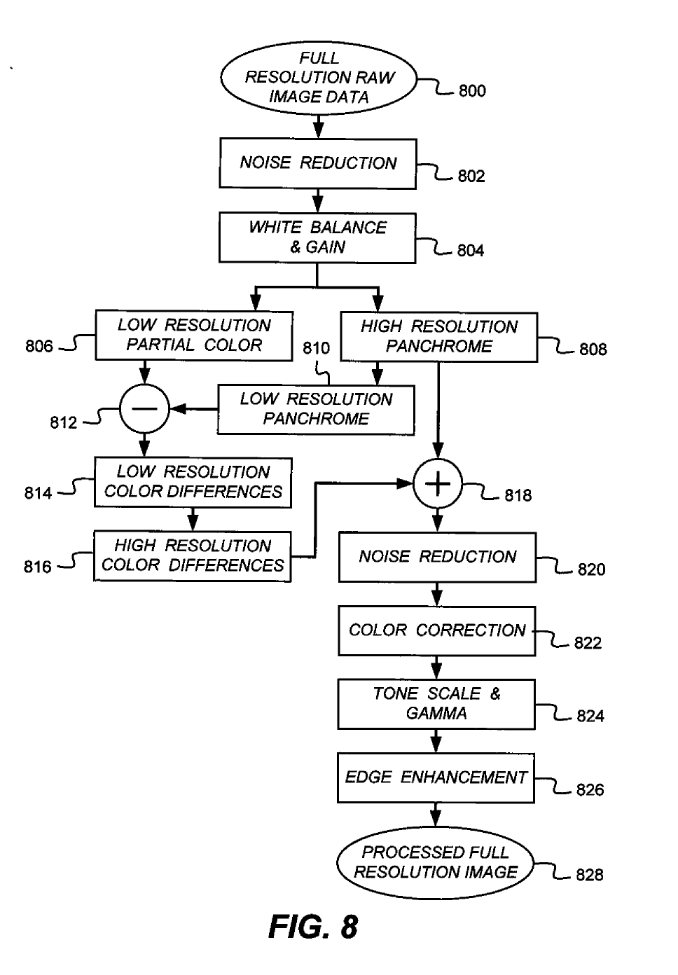

Referring now to FIG. 8, there is shown an image processing chain for full resolution image processing in an embodiment in accordance with the invention. The full resolution data is obtained from an image sensor incorporating a color filter array with both color and panchromatic pixels. This reference image processing chain is modeled after the one disclosed in commonly assigned United States Patent Application Publication 2007/0024879. Given full resolution raw image data 800 that includes color and panchromatic pixels, the processing steps are similar to those of FIG. 7, with the exception of the CFA interpolation step which accommodates the panchromatic pixels.

The invention has been described in detail with particular reference to certain preferred embodiments thereof; but it will be understood that variations and modifications can be effected within the spirit and scope of the invention.

Even though specific embodiments of the invention have been described herein, it should be noted that the application is not limited to these embodiments. In particular, any features described with respect to one embodiment may also be used in other embodiments, where compatible. And the features of the different embodiments may be exchanged, where compatible.

### PARTS LIST

100 image capture device
102 light
104 imaging stage
106 lens
108 image sensor
110 filter
112 iris
114 mechanical shutter
116 exposure controller
118 brightness sensor
120 analog signal processor
122 analog-to-digital converter
124 timing generator
126 image sensor stage
128 memory
130 digital signal processor
132 system controller
134 processing stage
136 program memory
138 bus
140 host interface
142 memory card
144 display
146 bus
148 system memory
150 memory card interface
152 socket
154 video encoder
156 display controller
158 user interface
160 viewfinder display
162 exposure display
164 status display
166 user inputs
200 image capture device
202 system-on-chip image sensor
204 integrated controller
300 image capture device
302 image sensor
304 image signal processor
306 applications processor
308 display
310 system memory
312 device
314 device or system-on-chip
402 bypass
404 fractional resolution image signal processor
406 multiplexer
414 system-on-chip
416 software program
500 cell
502 minimal repeating unit

1. A system-on-chip (SOC) comprising:
an image sensor;
an image signal processor connected to an output of the image sensor;
a bypass connected to the output of the image sensor; and
a multiplexer connected to an output of the image signal processor and an output of the bypass.

2. An image capture device comprising:
a system-on-chip (SOC) including:
an image sensor;
an image signal processor connected to an output of the image sensor;
a bypass connected to the output of the image sensor; and
a multiplexer connected to an output of the image signal processor and
an output of the bypass; and
an applications processor connected to an output of the multiplexer.

3. The image capture device as in claim 2, further comprising a system memory connected to the applications processor.

4. The image capture device as in claim 2, further comprising a display connected to the applications processor.

5. A method for processing images in an image capture device that includes an applications processor, a system memory, a display, and a system-on-chip (SOC) comprising an image sensor, an image signal processor connected to an output of the image sensor, a bypass connected to the output of the image sensor; and a multiplexer connected to an output of the image signal processor and an output of the bypass, wherein the applications processor is connected to an output of the multiplexer and the system memory and display are connected to the applications processor, the method comprising:
if fractional resolution image data is received from the image sensor, processing the fractional resolution image data using the image signal processor; and
transmitting the processed fractional resolution image data to the applications processor through the multiplexer; and
if full resolution image data is received from the image sensor, transmitting the full resolution image data to the applications processor through the bypass and multiplexer.

6. The method as in claim 5, further comprising processing the full resolution image data using the applications processor.

7. The method as in claim 6, further comprising storing the processed full resolution image data in the system memory.

8. The method as in claim 6, further comprising displaying the processed full resolution image data on the display.

9. The method as in claim 5, further comprising storing the full resolution image data in the system memory.

10. The method as in claim 5, further comprising displaying the full resolution image data on the display.
